(19) United States
(12) Patent Application Publication
(10) Pub. No.: US 2026/0149749 A1
(43) Pub. Date: May 28, 2026

(54) INTELLIGENT DATA INTEGRATION WITH WEB APIS IN CLOUD SYSTEMS

(71) Applicant: SAP SE, Walldorf (DE)

(72) Inventors: Dabin Feng, Shanghai (CN); Xia Yu, Shanghai (CN); Chen Feng, Shanghai (CN)

(21) Appl. No.: 18/960,154

(22) Filed: Nov. 26, 2024

(51) Int. Cl. H04L 67/133; G06F 9/50; H04L 67/1008

(52) U.S. Cl. CPC H04L 67/133; G06F 9/5027; H04L 67/1008

(57) ABSTRACT

Methods, systems, and computer-readable storage media for receiving a request of an API call from a client, the request including a query, determining a score for the request, the score representative of a burden that the request would place on technical resources, if the request were to be executed, in response to the score, providing a response including a set of actions without executing the request, orchestrating a set of API sub-calls based on the set of actions, each API sub-call returning a sub-call response, merging the sub-call responses to the set of API sub-calls to provide a final result, and returning the final result in response to the API call to the client.

### BACKGROUND

Enterprises can use enterprise applications to support and execute operations. Enterprise applications can be deployed in cloud computing environments, which includes execution of the enterprise applications within a data center of a cloud-computing provider (e.g., as part of an infrastructure-as-a-service (IaaS) offering). Cloud computing can be described as Internet-based computing that provides shared computer processing resources, and data to computers and other devices on demand. Users can establish respective sessions, during which processing resources, and bandwidth are consumed. During a session, for example, a user is provided on-demand access to a shared pool of configurable computing resources (e.g., computer networks, servers, storage, applications, and services). In some instances, clients (e.g., client-side computing devices) transmit requests to a cloud computing environment, which requests are routed to a server for processing.

### SUMMARY

Implementations of the present disclosure are directed to processing requests received through application programming interface (API) calls in cloud environments. More particularly, implementations of the present disclosure are directed to an intelligent API call client for resource-efficient processing of requests received through API calls in cloud environments.

In some implementations, actions include receiving a first request of a first API call from a client, the first request including a first query, determining a first score for the first request, the first score representative of a burden that the first request would place on technical resources, if the first request were to be executed, in response to the first score, providing a first response including a set of actions without executing the first request, orchestrating a set of API sub-calls based on the set of actions, each API sub-call returning a sub-call response, merging the sub-call responses to the set of API sub-calls to provide a first final result, and returning the first final result in response to the first API call to the client. Other implementations of this aspect include corresponding systems, apparatus, and computer programs, configured to perform the actions of the methods, encoded on computer storage devices.

These and other implementations can each optionally include one or more of the following features: providing a first response comprising a set of actions is executed in response to the first score being less than a threshold score response; the set of actions includes a fetch action and a merge action, the fetch action being executable as the set of API sub-calls and the merge action being executable to merge the sub-call responses; actions further includes receiving a second request of a second API call, the second request comprising a second query, determining a second score for the second request, the second score representative a burden that the second request would place on technical resources, if the second request were to be executed, in response to the second score, processing the second request to provide a second final result, and returning the second final result in response to the second API call; actions further include determining the set of actions from a set of query suggestions that are provided based on a set of rules, each rule corresponding to a factor contributing to the first score and providing a query suggestion to mitigate the factor; the first response includes primitive data type properties and binary properties; the primitive data type properties and the binary properties each includes a respective page size to determine a respective number of requests for retrieving records responsive to the first query; actions further include determining the set of actions from a set of query suggestions that are provided based on a set of rules, each rule corresponding to a factor contributing to the first score and providing a query suggestion to mitigate the factor; the first request of the first API call is received by an intelligent API client that provides the first request as an API call to an application server, an API scorer executed on the application server determining the first score; the first response is received by an API client orchestrator of the intelligent API client, the API client orchestrator orchestrating the set of API sub-calls in response to determining that the first response comprises the set of actions; and an API optimizer executed on the application server determines the set of query suggestions.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts a conceptual architecture in accordance with implementations of the present disclosure.

FIG. 3 depicts an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to processing requests received through application programming interface (API) calls in cloud environments. More particularly, implementations of the present disclosure are directed to an intelligent API call client for resource-efficient processing of requests received through API calls in cloud environments.

Implementations can include actions of receiving a request of an API call from a client, the request including a query, determining a score for the request, the score representative of a burden that the request would place on technical resources, if the request were to be executed, in response to the score, providing a response including a set of actions without executing the request, orchestrating a set of API sub-calls based on the set of actions, each API sub-call returning a sub-call response, merging the sub-call responses to the set of API sub-calls to provide a final result, and returning the final result in response to the API call to the client.

To provide further context for implementations of the present disclosure, and as introduced above, enterprises can use enterprise applications to support and execute operations. Enterprise applications can be deployed in cloud computing environments, which includes execution of the enterprise applications within a data center of a cloud-computing provider (e.g., as part of an infrastructure-as-a-service (IaaS) offering). Cloud computing can be described as Internet-based computing that provides shared computer processing resources, and data to computers and other devices on demand. Users can establish respective sessions, during which processing resources, and bandwidth are consumed. During a session, for example, a user is provided on-demand access to a shared pool of configurable computing resources (e.g., computer networks, servers, storage, applications, and services). In some instances, clients (e.g., client-side computing devices) transmit requests to a cloud computing environment, which requests are routed to a server for processing.

In cloud systems, functions can be exposed as web services. For example, calls can be made to one or more web services through an application programming interface (API), which can be referred to as a web services API, the web services executing functionality requested in the API call. In some examples, applications can call web service for internal integrations for internal module teams and/or external integration for end customer systems. For example, and as discussed in further detail herein, enterprises may have their own internal systems and call the web services API for data integration and/or secondary development.

As applications are increasingly moved to cloud systems, more and more web services API entities and functionalities are exposed. For example, a cloud system can have hundreds to thousands, if not more, of API entities and functions for internal and external customers. In many instances, the entities and functions are not insular, and can have multiple navigation properties that can be expanded to other entities. However, enterprises may not know the backend logic and how their queries impact backend servers. Consequently, individual users in an enterprise can submit queries, for example, through web services for as much data as possible in a single query with many deeply selected fields and deep expansion from one entity to other entities without considering the efficiency and/or performance. These kinds of usage can result in significantly large loads on backend servers in terms of computing resources demanded. These loads can also result in reduced quality of user experiences, as response times can take longer. In some instances, requests submitted through API calls can timeout resulting in retries and further consumption of resources.

For example, an employee resource database can be used for employee basic information integration, which may contain one or more properties. Example properties can include, without limitation, images, attachments, and the like. While users that are querying the employee resource databases do not require such properties, queries submitted in requests may still fetch the properties along with the basic information that is actually the target of the request. This results in wasted resources (e.g., needlessly expended processing, memory) and degraded performance (e.g., longer response times).

Deficiencies of traditional processing of API calls can be highlighted in the example context of data integration, which can be described as enabling enterprises to interact with a suite of systems provisioned by software vendors. Example systems in a suite of systems can include, without limitation, an enterprise resource planning (ERP) system, a customer relationship management (CRM) system, and a human capital management (HCM) system. In data integration, data of an enterprise that is distributed across disparate data sources can be consolidated and processed for consistency for use in various systems of a suite of systems. In this way, a single user query could trigger data fetches across multiple systems such as an ERP, CRM, HCM, etc. systems. All of this fetched data is then integrated together to form the one or more responses to the initial user query.

In the context of data integration, API calls can be made that include requests for data. For example, requests can include queries to query data sources and receive data responsive to the queries. As an increasing number of API resources are exposed for data integration, different enterprises can use different APIs for their data integration and different APIs have different performance characteristics in terms of time and technical resources consumed. Different enterprises can have different data volumes, even for the same web services API. Further, requests submitted through API calls can be time- and resource-inefficient and such requests can be described as heavy, which is descriptive of loads that the requests place on technical resources (e.g., processors, memory, bandwidth) of backend servers. Heavy requests (heavy API calls) results in poor performance in terms of time and technical resources consumed and can result in timeouts. If an API call times out, the API call can be repeated, further consuming technical resources. In some instances, multiple timeouts can result in failure of a data integration process.

Further, each API call is processed by a backend resource in a set of backend resources. As a result, the burden that a heavy request places on a backend resource cannot be distributed across multiple backend resources using, for example, a load balancing mechanism (e.g., round-robin).

To illustrate technical inefficiencies of heavy requests, the following non-limiting, example query can be considered:

Listing 1: Example Query

/users?$expand=educations,manager,jobInfo&$select=userId,usern
ame,resume,educations/duration,educations/school,educations/de
gree,manager/userId,manager/username,jobInfo/employment&$filte
r=department eq ‘IT Services’&$orderby=userId&$top=1000&
$skip=1000

The example of Listing 1 can be included in a request to an application server through an API call. The example of Listing 1 is considered heavy. For example, the example of Listing 1 includes a relatively large page size (e.g., 1000), requests that binary content (e.g., curriculum vitae (CV)) be returned along with primitive type information, and requests that data from nested resources (e.g., educations, manager, job information) by returned, all in a single API call. Here, the example of Listing 1 would place a relatively large burden on technical resources of the application server(s) processing the request and could result in multiple time outs, as well as failure of a data integration process that the request is submitted for. Further, this relatively large burden has to be born by a backend resource and is not distributable across multiple backend resources using load-balancing.

In view of the above context, implementations of the present disclosure are directed to an intelligent API call client for resource-efficient processing of requests received through API calls in cloud environments. As described in further detail herein, the request of an API call is scored based on burden that the request would place on a backend resource, and can be designated as heavy based on score. If a request is determined to be heavy, a set of query suggestions is determined for the request, a set of actions is determined based on the set of query suggestions, and multiple API sub-calls are executed. Responses of the sub-calls are merged to provided a final result that is responsive to the request of the (original) API call.

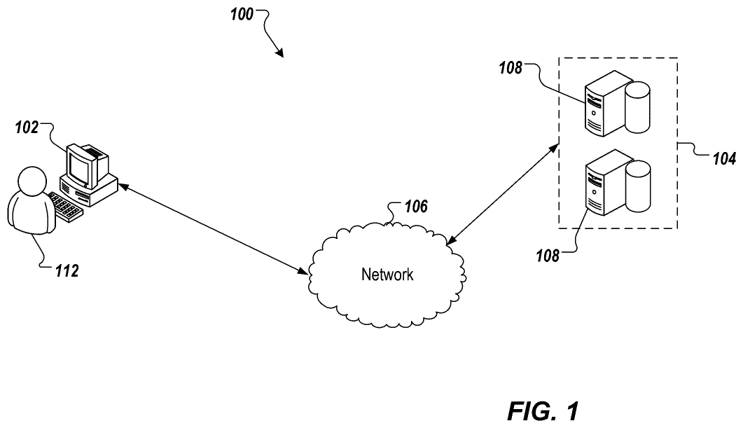

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In some implementations, the server system 104 can embody a cloud computing environment, in which one or more of the servers 108 are application servers that receive queries (e.g., as request made through API calls), process the queries, and provide results. For example, a web service hosed on a server 108 can receive a query from the client device 102. In accordance with implementations of the present disclosure, and as described in further detail herein, the server system 104 can host an intelligent API call client for resource-efficient processing of requests (including queries) received through API calls in cloud environments. As also described in further detail herein, the server system 104 can host an API processor, an API scorer, and an API optimizer that operate with the intelligent API client.

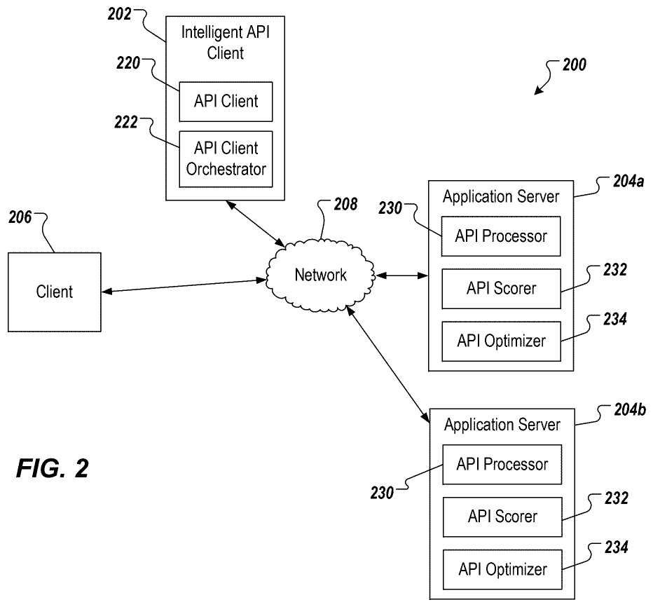

FIG. 2 depicts a conceptual architecture 200 in accordance with implementations of the present disclosure. In the example of FIG. 2, the conceptual architecture 200 includes an intelligent API client 202, an application server 204 (e.g., part of the server system 104 of FIG. 1), and a client 206. In some examples, the client 206 issues requests, as API calls, to the intelligent API client 202 over a network 208 (e.g., the network 106 of FIG. 1). As described in further detail herein, the intelligent API client 202 communicates with the application servers 204a, 204b over the network 208 to process the requests and return results to the client 206.

In further detail, the intelligent API client 202 includes an API client 220 and an API client orchestrator 222. In this example, the intelligent API client 202 provides functionality between a combination of the API client 220 and the API client orchestrator 222. In some examples, the API client 220 coordinates API calls (and/or sub-calls) to the application servers 204a, 204b. The application servers 204a, 204b each includes an API processor 230, an API scorer 232, and an API optimizer 234. In some examples, the API processor 230, the API scorer 232, and the API optimizer 234 are executed on the application server 204a, 204b, because the server-side executes API calls and can calculate scores according to resource usage, as API modeling and API implementation are done in server-side. Although two application servers 204a, 204b are depicted, it is contemplated that any appropriate number of application servers can be provided.

In some implementations, the API client 220 calls web services executed by the application servers 204a, 204b in response to requests received from the client 206. In some examples, the API scorer 232 receives a request (web services call) from the API client 220 and determines whether the request is heavy. In some examples, whether a request is heavy is determined based on a score that is calculated by the API scorer 232, the score being representative of a load that the request would put on resources of the application server 204, if the request were to be processed by the application server 204.

In further detail, each request (e.g., including a query) is processed by the API scorer 232 to provide a score that represents a complexity of the request in terms of a load that the request imparts on the web service and backend (the application server 204a, 204b). In scoring a request, multiple impact factors are accounted for, each impact factor having an associated weight. In some examples, each weight is configurable, and the sum of the weights is equal to 1. If a weight is configured as 0, it means the respective impact factor is ignored from consideration in scoring. Table 1 provides details on example impact factors considered in scoring queries:

TABLE 1
Example impact Factors for Scoring

| Impact Factor | Weight | Description |
|---|---|---|
| entity definition | w₁ | Backend entities vary, some are |
| | | complicated with many fields and |
| | | navigations to other entities, some are |
| | | very simple and isolated. Queries |
| | | against different entities |
| | | have different base complexity. |
| select fields | w₂ | Query syntax related to select fields. |
| deep expand | w₃ | Query syntax - related to navigation |
| | | size and depth from |
| | | one entity to other |
| | | entities (e.g., user expands to user |
| | | manager to job info. |
| filter | w₄ | Query syntax - related to filter fields |
| | | (e.g., filter condition size, depth of |
| | | nested filter condition). |
| database calls | w₅ | Database call count of one |
| | | internal/external request. |
| database SQLs | w₆ | Representative of each db sql |
| | | complexity, SQL join operations, |
| | | joined tables, set operations (union, |
| | | intersect, except). |
| IO and Response | w₇ | Data between application and |
| records | | database and records in response. |
| (e.g., page size, | | |
| top, skip, IO between | | |
| application and | | |
| backend) | | |

In some examples, a constraint is provided and includes that the sum of weights is equal to a set value (e.g., w₁+ . . . +w₇=1).

In some implementations, a score is provided for each impact factor and can be referred to as factor scores, which are combined to provide a total score (SCORE_TOTAL) for a query. In some examples, if the SCORE_TOTAL is below a threshold score, the request is determined to be heavy. In some examples, if the SCORE_TOTAL is not below a threshold score (e.g., 60), the request is determined not to be heavy.

Determining scores for requests (queries) is described in further detail in commonly assigned U.S. application Ser. No. 18/495,862, filed on Oct. 27, 2023, and entitled Protecting Cloud Systems Using Request Scores, the disclosure of which is expressly incorporated herein by reference in the entirety for all purposes.

If a request is determined not to be heavy, the request is processed by the application server 204a, 204b, a response is provided to the intelligent API client 202 and a final result is returned to the client 206. For example, the final result includes data responsive to a query of the request. If a request is determined to be heavy, the API optimizer 234 provides query suggestions for handling of the request. Query suggestions are described in further detail commonly assigned U.S. application Ser. No. 18/495,862 introduced above and incorporated by reference. In some examples, the query suggestions are used to rewrite a query as a set of sub-queries, which are provided in respective API sub-calls, as described in further detail herein.

In accordance with implementations of the present disclosure, the API optimizer 234 provides the query suggestions based on a set of rules. Table 2 provides an example of a set of rules that can be used:

TABLE 2
Example Rules

| Category | Factor | Rule | Example |
|---|---|---|---|
| IO | Page size | When IO score is bad | /users?$top=1000 |
| | | and request page size is | change to: |
| | | larger than default page | /users?$top=200 |
| | | size (e.g. 200), suggest | |
| | | API call with default | |
| | | page size. | |
| Select | Binary | If there is binary | /users?$select=userId,us |
| | property | property, divide binary | ername,resume&$top=100 |
| | | property query into | change to: |
| | | another API call. | /users?$select=userId,us |
| | | And the default page | ername&$top=100 |
| | | size is 10 for binary | /users?$select=resume&$t |
| | | property query. | op=10 |
| Expand | Navigation | One to many mapping | /users?$expand=education |
| | property | navigation property | s |
| | cardinality | expanding must be a | change to: |
| | | separate API call. | /users/{id}/educations |
| | | One to one mapping | /users?$expand=hr,manage |
| | | navigation property | r,job |
| | | could be grouped in one | change to: |
| | | separate call, default | /users/{id}?$expand=hr,m |
| | | page size is 5. | anager,job |
| | Deep expand | If the navigation expand | /users?$expand=manager/e |
| | | depth is larger than 1, | mpInfo |
| | | split the query into | change to: |
| | | progressive expands | /users?$expand=manager |
| | | | /empInfo?$filer=userId |
| | | | eq {id} |
| Filter | Arithmetic | Preprocess of arithmetic | /products?$filter=price |
| | operations | operations to simplify | add 5 gt 10 |
| | preprocessing | DB queries. | change to: |
| | | This can be done on the | /products?$filter=price |
| | | application server side. | gt 5 |
| | | | /products?$filter=price |
| | | | mul 2 gt 200 |
| | | | change to: |
| | | | /products?$filter=price |
| | | | gt 100 |

In some implementations, the API optimizer 234 provides a set of query suggestions to the API processor 230, which processes the set of query suggestions to provide a set of actions. In some examples, the API processor 230 returns a response to the API client orchestrator 222, the response including the set of actions. An example response can be provided as:

Listing 2: Example Response

```
{
  “value”: [
    {
      “userId”: “1”,
      “username”: “tom”,
      “@actions”: [
        {
          “action”: “fetch-merge-expand”,
          “target”: “educations”,
          “link”: “/users/1/education?$select=school,
degree,duration”
        },
        {
          “action”: “fetch-merge-expand”,
          “target”: “jobInfo”,
          “link”: “/users/1/jobInfo”
        }
      ]
    }
  ],
  “@actions”: [
    {
      “action”: “fetch-merge”,
      “links”: [
        “/users?$select=userID,username&$top=200&$skip=
1000”,
        “/users?$select=resume&$top=10&$skip=1000”
      ]
    }
  }
}
```

The example of Listing 2 is returned by the API processor 230 to the API client orchestrator 222 and includes partial data and following actions. Listing 2 is an example of an optimized API response and includes separate primitive data type properties from binary properties and separate properties from navigations. In the example of Listing 2, the primitive data type properties have a page size of 200, such that five (5) requests are provided for retrieving 1000 records (i.e., 5×200=1000). Also, the binary property has a page size of ten (10), such that 100 requests are provided for retrieving the 1000 records (i.e., 100×10=1000). For the separate properties from navigations, 1000 requests are sent to retrieve education data and 1000 requests are sent to retrieve job data. Responses to the requests are merged into a final request, as described herein.

In accordance with implementations of the present disclosure, actions of the set of actions included in the response can be executed as queries using API sub-calls. For example, each action can be executed as a query submitted to the application server 204a, 204b in an API sub-call. In some examples, the API client 220 submits the API sub-calls (e.g., to the application server 204a and the application server 204b). In some examples, the API client orchestrator 222 orchestrates the API sub-calls with the API client 220 and merges respective responses into a final result. For example, and with non-limiting reference to the example of Listing 2, the user instance with user identifier (userId) equal to 1 is returned and the API client orchestrator 222 executes the action of the action type fetch-merge-expand with a target of educations. After executing an API call (e.g., /users/1/eductions?$select=school, degree, duration), the API client orchestrator 222 merges the response into the user instance. For example:

Listing 3: Example Merge of User Instance

```
{
  “userId”: “1”,
  “username”: “tom”,
  “educations”: [
    Education API response
  ]
}
```

Using the API client orchestrator 222, the API sub-calls are transparent to the client 206. That is, for example, the client 206 invokes an API call and receives an API response (final result) without awareness of whether the API response is provided using API sub-calls. In some examples, and as described in further detail herein, in order to make full use of resources of the application server 204a, 204b in handling of API calls, including API sub-calls, the API client orchestrator 222 enables API calls to be made in parallel. For example, the API client orchestrator 222 initiates execution of the API sub-calls (e.g., in parallel to the application server 204a and the application server 204b) and merges responses to the API sub-calls into a final result.

To illustrate implementations of the present disclosure, the example query of Listing 1 can be considered. As noted above, the example query of Listing 1 is considered heavy. In response, the example query of Listing 1 can be optimized into a set of actions that results in the following API sub-calls:
1000 API sub-calls to retrieve education information,
1000 API sub-calls to retrieve job information,
5 API sub-calls to retrieve user basic information, and
100 sub-API calls to retrieve user resume.

The numbers of API sub-calls are discussed above with reference to Listing 2. In this example, a single, heavy API call has been broken down into 2105 API sub-calls that can be distributed across multiple application servers. It can be noted that, in terms of load placed on backed servers (e.g., the application server 204a, 204b), each API sub-call places a fraction of the load of the single, heavy API call. Further, because there are multiple API sub-calls, processing of the API sub-calls can be distributed across multiple backend resources (e.g., the application server 204a and the application server 204b). For example, a load balancing mechanism (e.g., round-robin) can be used to process the multiple API sub-calls across multiple backend resources. As such, at least a portion of the API sub-calls can be processed in parallel. Further, because each API sub-call is relatively light in terms of burden on the backend resources, occurrences of time outs can be reduced, if not eliminated. In this manner, technical resources are conserved as, for example, retries of API sub-calls is avoided. Further, reduction, if not elimination, of time outs can reduce, if not also eliminate, occurrences of failures of data integration processes.

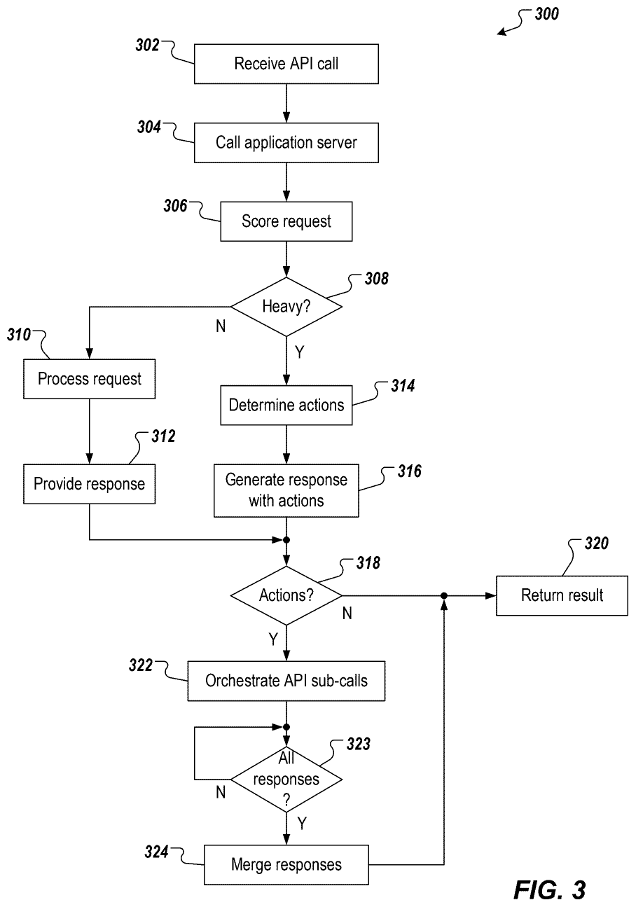

FIG. 3 depicts an example process 300 that can be executed in accordance with implementations of the present disclosure. In some examples, the example process 300 is provided using one or more computer-executable programs executed by one or more computing devices.

A web services call is received (302). For example, and as described herein with reference to FIG. 2, the client 206 can issue a request (as an API call) to a web service through the intelligent API client 202, the request including a query for querying a database. An application server is called (304). For example, and as described herein, the API client 220 of the intelligent API client 202 calls the application server 204 for processing of the request. The request is scored (306). For example, and as described herein, the API scorer 232 executing on the application server 204 determines a score for the request, the score representing a burden that the request would place on technical resources of the application server 204, if the request were to be executed.

It is determined whether the request is considered heavy (308). For example, and as described herein, the score determined for the request is compared to a threshold score and is selectively designated as heavy in response to the comparison. If the request is not considered heavy, the request is processed (310) and a response is returned (312). For example, and as described herein, the request is processed by the application server 204 to retrieve data responsive to the request and the response that is returned includes the data. If the request is considered heavy, a set of actions is determined (314) and a response with the set of actions is generated and returned (316). For example, and as described herein, the API optimizer 234 processes the request based on a set of rules to determine a set of query suggestions, and the API processor 230 processes the set of query suggestions to provide a set of actions that are included in a response.

It is determined whether the response includes a set of actions (318). For example, and as described herein, the response received by the intelligent API client 202 is reviewed to determine whether the response includes a set of actions. If the response does not include a set of actions, a result to the request is returned (320). For example, and as described herein, a final result is returned to the client 206 and includes data that is retrieved responsive to the request. If the response does include a set of actions, a set of API sub-calls is orchestrated (322) and responses from the set of API sub-calls are merged (324). For example, and as described herein, the API client orchestrator 222 orchestrates execution of a set of API sub-calls to the application server 204, each API sub-call corresponding to a sub-query representative of a portion of the request. A response is received for each API sub-call and the responses are merged to provide a result. In some examples, each individual response to each API sub-call includes an identifier indicating that the response is to be merged with the responses to other API sub-calls into single response back to client 206. The intelligent API client 202 checks if all responses for all sub-calls has been returned (323). When all responses to all sub-calls associated with the initial, heavy call have been received, the results to the sub-call requests are merged into a single response (324) and the complete response is returned (320). For example, and as described herein, a final result that is provided from merging responses to the API sub-calls, and is returned to the client 206.

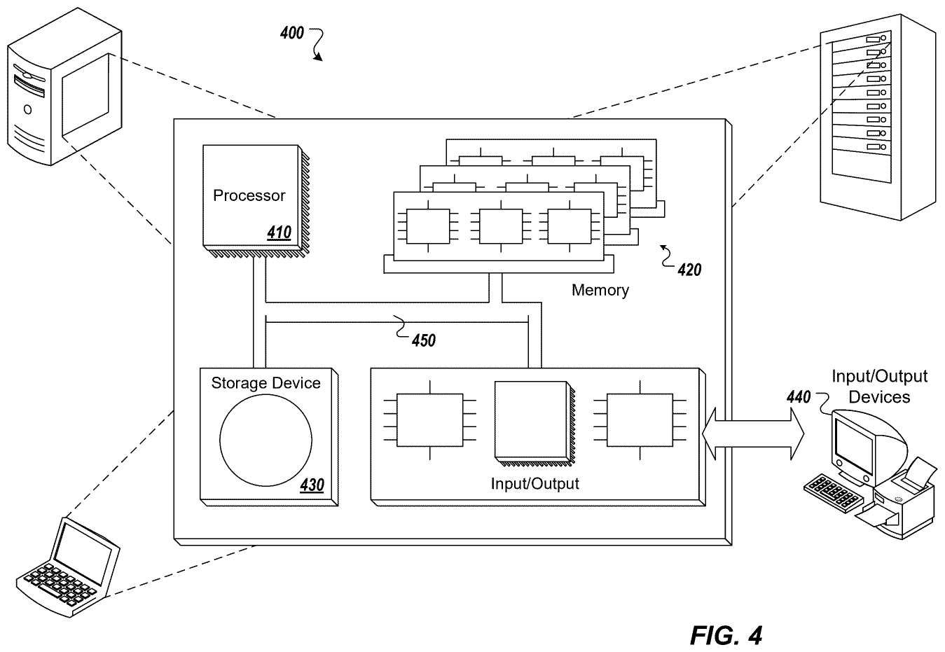

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a backend component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for evaluating queries received through web service application programming interfaces (APIs) to improve query processing and performance of backend systems, the method being executed by one or more processors and comprising:
receiving a first request of a first API call from a client, the first request comprising a first query;
determining a first score for the first request, the first score representative of a burden that the first request would place on technical resources, if the first request were to be executed;
in response to the first score, providing a first response comprising a set of actions without executing the first request;
orchestrating a set of API sub-calls based on the set of actions, each API sub-call returning a sub-call response;
merging the sub-call responses to the set of API sub-calls to provide a first final result; and
returning the first final result in response to the first API call to the client.

2. The method of claim 1, wherein providing a first response comprising a set of actions is executed in response to the first score being less than a threshold score response.

3. The method of claim 1, wherein the set of actions comprises a fetch action and a merge action, the fetch action being executable as the set of API sub-calls and the merge action being executable to merge the sub-call responses.

4. The method of claim 1, further comprising:
receiving a second request of a second API call, the second request comprising a second query;
determining a second score for the second request, the second score representative a burden that the second request would place on technical resources, if the second request were to be executed;
in response to the second score, processing the second request to provide a second final result; and
returning the second final result in response to the second API call.

5. The method of claim 1, further comprising determining the set of actions from a set of query suggestions that are provided based on a set of rules, each rule corresponding to a factor contributing to the first score and providing a query suggestion to mitigate the factor.

6. The method of claim 1, wherein the first response comprises primitive data type properties and binary properties.

7. The method of claim 6, wherein the primitive data type properties and the binary properties each comprises a respective page size to determine a respective number of requests for retrieving records responsive to the first query.

8. A non-transitory computer-readable storage medium coupled to one or more processors and having instructions stored thereon which, when executed by the one or more processors, cause the one or more processors to perform operations for evaluating queries received through web service application programming interfaces (APIs) to improve query processing and performance of backend systems, the operations comprising:
receiving a first request of a first API call from a client, the first request comprising a first query;
determining a first score for the first request, the first score representative of a burden that the first request would place on technical resources, if the first request were to be executed;
in response to the first score, providing a first response comprising a set of actions without executing the first request;
orchestrating a set of API sub-calls based on the set of actions, each API sub-call returning a sub-call response;
merging the sub-call responses to the set of API sub-calls to provide a first final result; and
returning the first final result in response to the first API call to the client.

9. The non-transitory computer-readable storage medium of claim 8, wherein providing a first response comprising a set of actions is executed in response to the first score being less than a threshold score response.

10. The non-transitory computer-readable storage medium of claim 8, wherein the set of actions comprises a fetch action and a merge action, the fetch action being executable as the set of API sub-calls and the merge action being executable to merge the sub-call responses.

11. The non-transitory computer-readable storage medium of claim 8, wherein operations further comprise:
receiving a second request of a second API call, the second request comprising a second query;
determining a second score for the second request, the second score representative a burden that the second request would place on technical resources, if the second request were to be executed;
in response to the second score, processing the second request to provide a second final result; and
returning the second final result in response to the second API call.

12. The non-transitory computer-readable storage medium of claim 8, wherein operations further comprise determining the set of actions from a set of query suggestions that are provided based on a set of rules, each rule corresponding to a factor contributing to the first score and providing a query suggestion to mitigate the factor.

13. The non-transitory computer-readable storage medium of claim 8, wherein the first request of the first API call is received by an intelligent API client that provides the first request as an API call to an application server, an API scorer executed on the application server determining the first score.

14. The non-transitory computer-readable storage medium of claim 13, wherein the first response is received by an API client orchestrator of the intelligent API client, the API client orchestrator orchestrating the set of API sub-calls in response to determining that the first response comprises the set of actions.

15. The non-transitory computer-readable storage medium of claim 13, wherein an API optimizer executed on the application server determines the set of query suggestions.

16. A system, comprising:
a computing device; and
a computer-readable storage device coupled to the computing device and having instructions stored thereon which, when executed by the computing device, cause the computing device to perform operations for evaluating queries received through web service application programming interfaces (APIs) to improve query processing and performance of backend systems, the operations comprising:
receiving a first request of a first API call from a client, the first request comprising a first query;
determining a first score for the first request, the first score representative of a burden that the first request would place on technical resources, if the first request were to be executed;
in response to the first score, providing a first response comprising a set of actions without executing the first request;
orchestrating a set of API sub-calls based on the set of actions, each API sub-call returning a sub-call response;
merging the sub-call responses to the set of API sub-calls to provide a first final result; and
returning the first final result in response to the first API call to the client.

17. The method of claim 16, wherein providing a first response comprising a set of actions is executed in response to the first score being less than a threshold score response.

18. The method of claim 16, wherein the set of actions comprises a fetch action and a merge action, the fetch action being executable as the set of API sub-calls and the merge action being executable to merge the sub-call responses.

19. The method of claim 16, wherein operations further comprise:
receiving a second request of a second API call, the second request comprising a second query;
determining a second score for the second request, the second score representative a burden that the second request would place on technical resources, if the second request were to be executed;
in response to the second score, processing the second request to provide a second final result; and
returning the second final result in response to the second API call.

20. The method of claim 16, wherein operations further comprise determining the set of actions from a set of query suggestions that are provided based on a set of rules, each rule corresponding to a factor contributing to the first score and providing a query suggestion to mitigate the factor.
